(19) United States
(12) Patent Application Publication
(10) Pub. No.: US 2010/0171742 A1
(43) Pub. Date: Jul. 8, 2010

(54) Method and Apparatus for Information Gathering and Display

(76) Inventor: Daniel B. Dobkin, New Hyde Park, NY (US)

Correspondence Address: David Henn, Attorney, 2604 Elmwood Avenue, Suite 277, Rochester, NY, 14618, US

(21) Appl. No.: 12/406,104

(22) Filed: Mar. 17, 2009

Related U.S. Application Data
(60) Provisional application No. 61/036,990, filed on Mar. 17, 2008.

(51) Int. Cl. G06T 11/20

(52) U.S. Cl. 345/440

(57) ABSTRACT

Graphical variable indicators convey information gleaned from data gathered from a user interface or storage. In an example embodiment, a polygon drawn from values of the respective variable indicators conveys the information. In a medical implementation, the polygon drawn from patent related data quickly and easily conveys the status of a patient. Preferably, the graphical variable indicators include previous, current, and desired values for the variables. Thus, a preferred embodiment includes a polygon for each of the previous, current, and desired values for the variables.

### CROSS-REFERENCE TO RELATED APPLICATIONS

This application claims the benefit of the filing date of U.S. Provisional Patent Application No. 61/036,990, filed 17 Mar. 2008.

### BACKGROUND AND SUMMARY

Many types of information are analyzed in many different fields, but there are a limited number of ways in which the data can be represented. Line graphs, bar graphs, and pie charts can show trends of a single variable, but when many variables are to be represented visually, these types of representations prove difficult to decipher. In addition, there are types of information that currently have no appropriate visual representation apart from cumbersome status sheets that are also difficult to decipher.

An excellent example of information needing a new representation is the information currently presented in medical care plans. In the medical establishment, there is a need for doctors, nurses, and other health care personnel to be able to quickly assess the status of a patient. Perusal of a patient's entire medical record can provide the required information, but is far too time intensive. In longer term care situations, medical professionals developed a part of the medical record called a “care plan” that attempts to provide a “snapshot” of a patient's problems and treatment plan for each problem.

Paper-based care plans have been used for many, many years. In addition to reflecting the status of the care and condition of a patient at any particular moment in time, the care plan includes specific information about what is being treated, how it is being treated, and what progress is being made. The care plan strives to enable those new to a patient's care to get up to speed with the patient's condition and plan of care, as well as serving as a ready reference for those long involved with the patient. However, the care plan is still a large, cryptic document that can take hours to decipher. An example of a care plan 10 is shown in FIG. 1. As can be seen in the FIG., all required information is present, but it is difficult to decipher the information to obtain meaningful interpretations of the information and/or to impart knowledge. The care plan is thus a very good way to record information, but not a very good way to retrieve information.

With the advent of powerful, relatively inexpensive computers, many attempts have been made to transform the existing paper-based care plan document into an online format. Now Federal regulations require hospitals to have such online systems, known commonly as Electronic Medical Record (EMR) systems. None of the prior art systems really work, however, including those currently being installed in hospitals world wide. No one who doesn't deal with the patients represented in the online care plans every single day can sit in a meeting and know whether the patient is improving, staying the same, or backsliding. Goals are typically supposed to be set every two weeks, but are oversimplified to things like “move his little finger” instead of having more significant markers.

The major disadvantage of prior art systems is that none of them have done any more than create virtual paper care plans. While this reduces storage requirements, it is still very difficult to glean relevant information from prior art systems, and the systems are very expensive, costing millions of dollars per installation. In fact, current prior art systems are often so cumbersome, obtuse, and or time-intensive that many physicians abandoned them in favor of the old plain paper care plan. In light of the result, the expenditure is simply not justified. Thus, there is a need for an EMR system that medical personnel will continue to use, perhaps even use gladly.

In the movement of care plans from paper to the virtual world, no one has taken the opportunity to re-invent what the record does, or can do, by decoupling the input and output modalities. Thus, there is a need for a new EMR system that employs new representations of existing data, decouples input and output modalities, and provides clear, quickly and easily understandable updates of patient status.

Embodiments disclosed herein meet the need for a better manner of representing information by reinventing the documentation model, gathering data in one format, and presenting it in a different format, data can be represented in a quickly decipherable manner that provides more information to the observer than prior art methods can while providing a system that can be used for small numbers or great numbers of records. In other words, embodiments provide a system for the graphical display of the changes in specific fact-sets over time, to enable better retrospective analysis and prospective decision-making. The implementation of embodiments handling EMRs and care plans will be described herein as an example, but embodiments can be applied to many other types of information.

With EMRs in particular, embodiments create a new EMR centered around patient care rather than documenting care plans. By reinventing the documentation model, gathering data in one format and presenting it in another, embodiments emphasize development of patient-centered care plans that strive for a particular outcome. This yields an outcome-focused system that is flexible, extensible, and scalable, equally usable for 5 or 5000 patients. Embodiments can be easily tailored to the needs of a particular installation, tailored to the needs of particular patients, and can be expanded upgraded as required with far less trouble than prior art systems.

At their cores, all EMRs simply conduct data gathering and information sharing. Ideally, the goal of an EMR is that all members of team are fully informed, can gain an understanding of how different disciplines affect each other, can understand how patient care progresses across all disciplines, and can discern the outcome of treatment(s). The EMR display should be as accessible to newcomers as to those intimately familiar with patient.

In a data gathering and information sharing system according to embodiments, raw data is a collection of data points with no particular pattern and which tell very little; information adds context, and some patterns are established and discernible; knowledge describes how one acts upon particular information; and wisdom describes when to use the knowledge or act upon information. Data is the trees, and information is the forest.

Embodiments avoid gathering and sharing information in the same manner by gathering data in a conventional fashion, but by representing much information graphically. The graphical display of information is more easily interpreted and understood than current information presentation arrangements, which are typically exclusively textual.

Embodiments are patient oriented and patient specific, displaying information tailored to a specific patient's needs. This is achieved by gathering only data relevant to a specific patient and the focus of information sharing should be patient outcome, as opposed to other factors, such as insurance reimbursement, malpractice action avoidance, and the like.

Embodiments use established and well-understood developmental benchmarks as rather than ad-hoc goals as the measure of patient progress and therapeutic success. Further, the inclusion of interdisciplinary data gathering and display allow flexible and easy integration into future implementations.

### BRIEF DESCRIPTION OF THE DRAWINGS

FIG. 1 shows a prior art paper care plan.

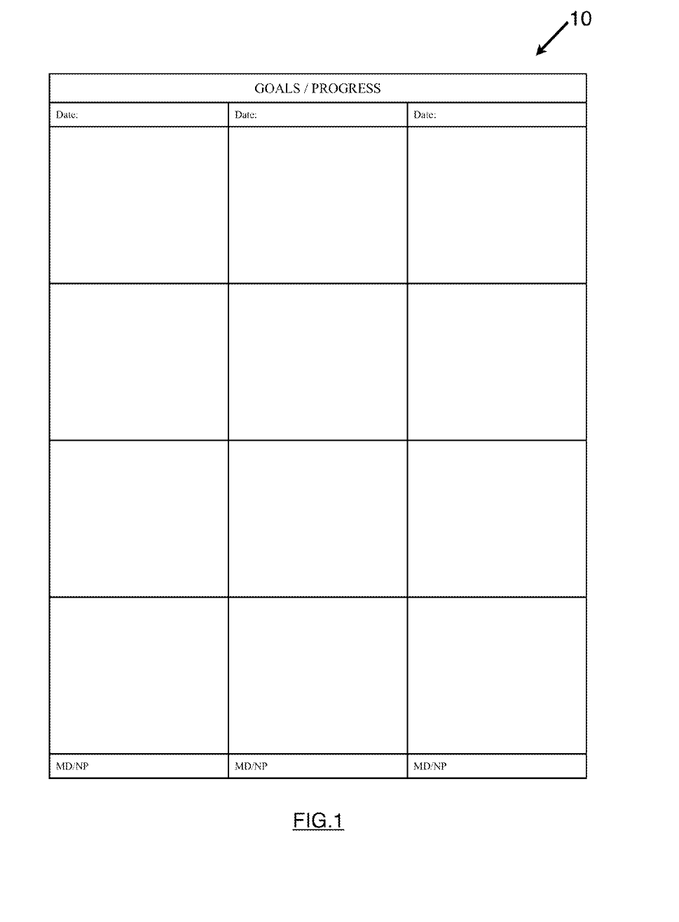

FIG. 2 is a schematic representation of an information sharing interface according to embodiments.

FIG. 3 is a schematic representation of a graphical portion of an information sharing interface according to embodiments.

FIG. 4 is a schematic representation of a textual portion of an information sharing interface according to embodiments.

FIG. 5 is a schematic representation of an information sharing interface according to embodiments.

FIG. 6 is a schematic representation of an information sharing interface according to embodiments.

### DESCRIPTION

A data gathering interface of embodiments applied to the EMR/care plan of the medical establishment can include a conventional arrangement. Embodiments can even employ existing databases of patient records from prior art EMR systems as a source of data, as well as interfaces similar to those with which users are familiar for the gathering of new data. Preferably, an axis-selection pane is provided, which pane is preferably pre-populated with admitting diagnoses so that a nurse, attending physician, or other user can simply verify and not spend time making selections for each admission. Additionally, data including vaccination data, nutritional goals, therapeutic achievement, and many other factors can be entered into the EMR system of embodiments to provide a full record of a patient's history, condition, outcome goal, and treatment to achieve the outcome goal. In non-medical embodiments, other variables can be included as appropriate.

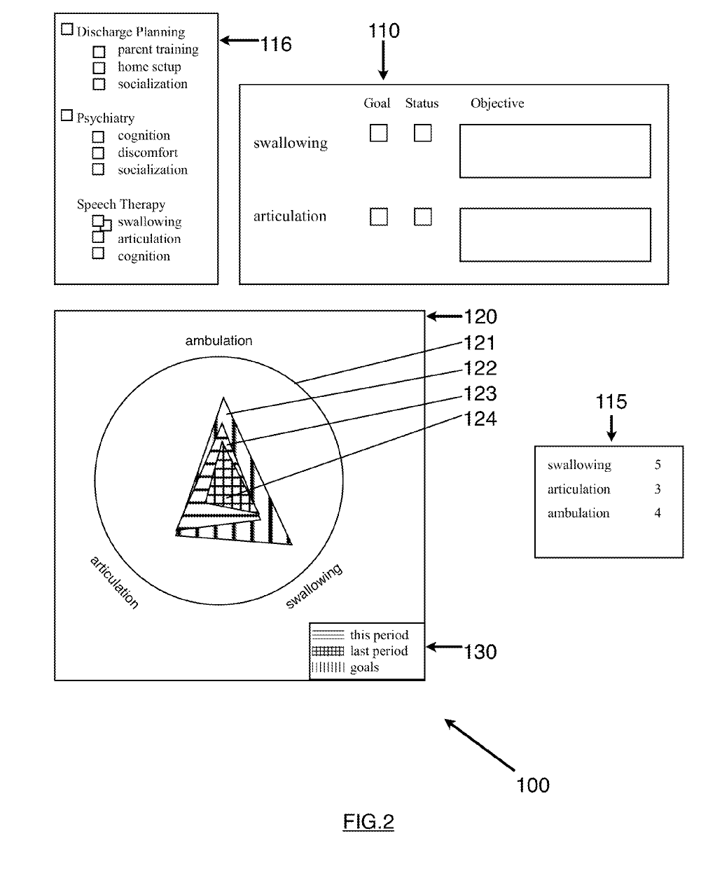

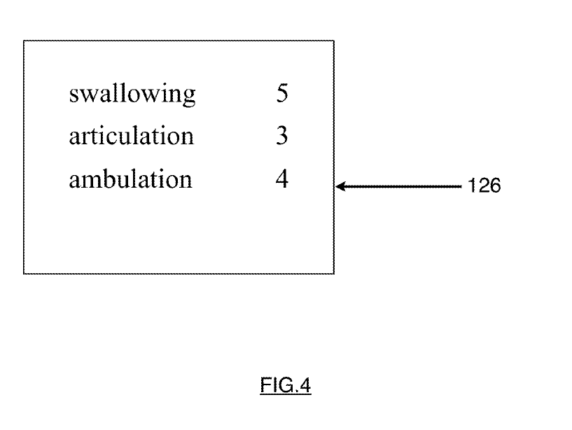

FIG. 2-4 show an information sharing interface 100 including an axis selection pane 110 from which one of a plurality of axes can be selected. Each of the plurality of axes represents a particular characteristic or other variable useful to the user. For example, an information sharing interface could display all traumatic brain injury (“TBI”) admissions over a specified period of time and show status at both admission and discharge. Additionally, the information sharing interface could display all patients on the “Blue” unit who have not received a particular vaccine. Embodiments could further display information grouping patients by various identifiers, such as impairment code classes, reflecting normative data, such as age normal data for particular variables, and displaying risk-adjusted data, such as progress vs. developmental benchmarks.

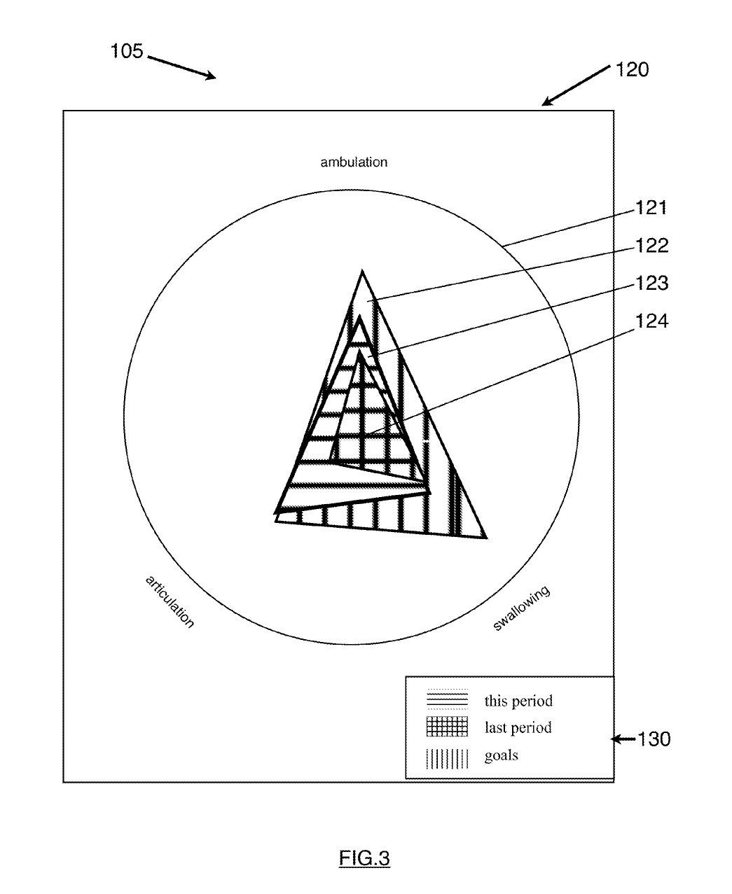

The information sharing interface of embodiments preferably includes a graphical display element 120, such as a circle on the perimeter of which appear indicators 121 of the characteristic variables that are to be displayed at substantially equal intervals. Each variable then has a radial scale extending from the center of the graphical display element 120 on which respective data points 122 can be displayed. By connecting the plotted data points 122, a polygon 123 is formed by the lines 124 connecting the data points 122. As seen in FIGS. 2 and 3, when three variables are to be displayed, the graphical display element 120 has three indicators 121 on its perimeter. To convey the patient status, the values of the variables are used to describe a polygon 123 whose vertices appear on axes that extend from a center of the circle toward the indicators 121 on the perimeter of the circle. In a preferred embodiment, the information sharing display conveys the status of the patient at a previous meeting, the status of the patient at a current date, and the desired status of the patient. Thus, three triangles are displayed in embodiments, which triangles overlap. To distinguish the three triangles, embodiments preferably assign different colors to the previous, current, and desired values of the variables. With such a display, it is easy for a care team member to quickly discern the patient's status and progress toward the desired outcome.

As seen in FIG. 2, embodiments preferably include a three pane arrangement in the information sharing interface 100. A first pane 105 includes the graphical display substantially as described above. However, a second pane 110, the axis selection pane, can include the various variables that can be displayed in the information sharing interface first pane, and a third pane 115 can display more conventional textual information for confirmation of the values being displayed. An additional textual display 116 can convey additional aspects of the data and/or information.

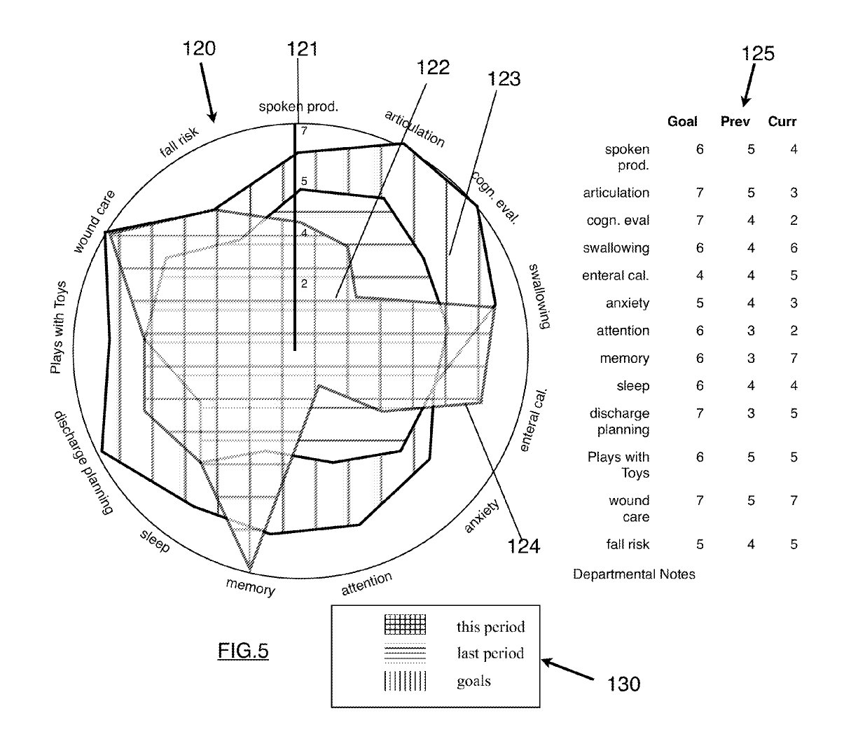

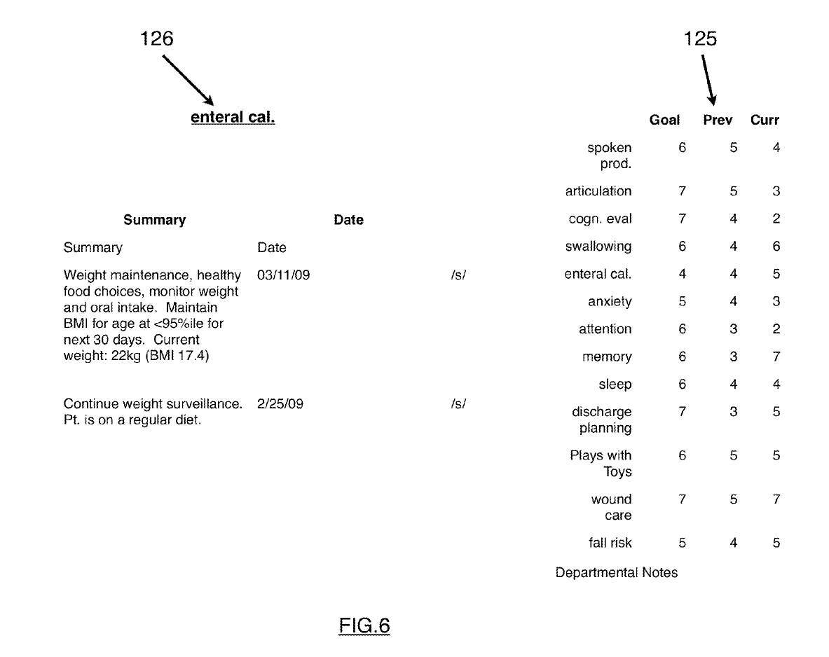

An additional example is seen in FIGS. 5 and 6, in which many more variable indicators 121 are present on the perimeter of the graphical display element 120. Thus, the polygons 123 formed by the lines 124 connecting the data points 122 are more complex than those shown in FIGS. 2 and 3. As seen, this example includes the panes 105, 110, 115, 116 to convey information in similar fashion to those in the example shown in FIGS. 2-4.

As should be apparent, the exemplary circle/polygon display shown in FIGS. 2-6 could be replaced with a number of different graphical interfaces to express prior, current, and desired status of a patient. For example, though not preferred because of limitations on what they can display, a bar graph could be used, or a line graph, or a pie chart array. Whatever graphical format is chosen, it should quickly and easily convey the various states of the variables displayed. For example, in medical applications, the graphical format should quickly and easily convey prior, current, and desired status of a patient.

A method according to embodiments is realized via, and a system according to embodiments includes, computer-implemented processes and apparatus for practicing such processes, such as a computer processor. Additionally, an embodiment includes a computer program product including computer code, such as object code, source code, or executable code, on tangible media, such as magnetic media (floppy diskettes, hard disc drives, tape, etc.), optical media (compact discs, digital versatile/video discs, magneto-optical discs, etc.), random access memory (RAM), read only memory (ROM), flash ROM, erasable programmable read only memory (EPROM), or any other computer readable storage medium on which the computer program code is stored and with which the computer program code can be loaded into and executed by a computer. When the computer executes the computer program code, it becomes an apparatus for practicing the invention, and on a general purpose microprocessor, specific logic circuits are created by configuration of the microprocessor with computer code segments. A technical effect of the executable instructions is to display data in a new fashion that provides more information more quickly and easily than previous data display arrangements. An additional technical effect of the executable instructions is to gather data in one format and display it in a different format to facilitate perusal and interpretation of the data.

The computer program code is written in computer instructions executable by the controller, such as in the form of software encoded in any programming language. Examples of suitable programming languages include, but are not limited to, assembly language, VHDL (Verilog Hardware Description Language), Very High Speed IC Hardware Description Language (VHSIC HDL), FORTRAN (Formula Translation), C, C++, C#, Java, ALGOL (Algorithmic Language), BASIC (Beginner All-Purpose Symbolic Instruction Code), APL (A Programming Language), ActiveX, HTML (HyperText Markup Language), XML (eXtensible Markup Language), and any combination or derivative of one or more of these.

Any flow diagrams depicted herein are just one example. There may be many variations to this diagram or the steps (or operations) described therein without departing from the spirit of the invention. For instance, the steps of the method described and/or claimed herein may be performed in a differing order or steps may be added, deleted or modified. All of these variations are considered a part of the claimed invention.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An information gathering and display apparatus comprising:
a conventional data gathering interface; and
a graphical information sharing interface including at least a plurality of variable indicators.

2. The information gathering and display apparatus of claim 1 wherein the graphical information sharing interface further comprises a respective graphical element for each variable indicator.

3. The information gathering and display apparatus of claim 2 wherein the graphical information sharing interface comprises a circle with a perimeter on which the plurality of variable indicators are substantially equidistantly displayed.

4. The information gathering and display apparatus of claim 3 wherein the graphical information sharing interface comprises a polygon drawn from respective sets of values of the plurality of variables.

5. The information gathering and display apparatus of claim 4 wherein the polygon is formed by lines connecting radial values of respective variable represented by respective ones of the plurality of variable indicators.

6. The information gathering and display apparatus of claim 4 wherein the respective sets comprise previous, current, and desired values of the plurality of values.

7. The information gathering and display apparatus of claim 1 wherein the graphical information sharing interface variable indicators include indicators for previous values, current values, and desired values of the variables.

8. The information gathering and display apparatus of claim 1 in which the information gathered is medical patient related information.

9. An information gathering and display method comprising:
gathering data with a conventional data gathering interface; and
displaying the data in a graphical information sharing interface including at least a plurality of variable indicators.

10. The information gathering and display method of claim 9 wherein displaying the data further comprises displaying a respective graphical element for each variable indicator.

11. The information gathering and display method of claim 10 wherein displaying the data further comprises displaying a circle with a perimeter on which the plurality of variable indicators are substantially equidistantly displayed.

12. The information gathering and display method of claim 11 wherein displaying the data further comprises using a radial scale for each of the plurality of variable indicators.

13. The information gathering and display method of claim 12 wherein displaying the data further comprises connecting respective radial values of the variables represented by the plurality of variable indicators.

14. The information gathering and display method of claim 11 wherein displaying the data further comprises displaying a polygon drawn from respective sets of values of the plurality of variables.

15. The information gathering and display method of claim 11 wherein the respective sets comprise previous, current, and desired values of the plurality of values.

16. The information gathering and display method of claim 9 wherein the graphical information sharing interface variable indicators include indicators for previous values, current values, and desired values of the variables.

17. The information gathering and display method of claim 9 wherein the data gathered is medical patient related information.
